(19) United States
(12) Patent Application Publication
(10) Pub. No.: US 2001/0035051 A1
(43) Pub. Date: Nov. 1, 2001

(54) Vacuum monitor and vacuum sensor

(76) Inventor: Robert Frank Karlicek, Fullerton, CA (US)

Correspondence Address: Robert F. Karlicek, 1920 Camino Centroloma, Fullerton, CA, 92833, US

(21) Appl. No.: 09/803,554

(22) Filed: Mar. 12, 2001

Related U.S. Application Data
(60) Provisional application No. 60/196,894, filed on Apr. 13, 2000.

(51) Int. Cl. G01L 19/04

(52) U.S. Cl. 73/708

(57) ABSTRACT

The system and apparatus described herein relate to the measurement of vacuum pressure using a Vacuum Sensor (thermocouple) producing a voltage that is connected by cable to a portable, battery operated Vacuum Monitor instrument which converts it to a vacuum pressure and displays it in digital format on an LCD. The Monitor automatically supplies the proper filament current required by the Sensor, and the operation of the system is controlled by a microprocessor in the Monitor. The system makes it possible to measure vacuum pressure without external power and eliminates the need for manually operated switches and manual adjustments. A Test Sensor is provided with the Monitor to enable performing a fill functional and calibration test of the Monitor.

This application references provisional Patent Application No. 60/196,894, filed on Apr. 13, 2000, entitled Vacuum Monitor and Vacuum Sensor.

### BACKGROUND OF THE INVENTION

This invention relates to the use of a thermocouple connected to a filament in a Vacuum Sensor (hereinafter called Sensor) that is mechanically attached to a vacuum enclosure, and which produces a voltage that is a function of the pressure in the enclosure. Electrical current is supplied to heat the filament which, in turn, is cooled by the air in the enclosure; thus, the lower the pressure in the enclosure, the hotter the filament becomes and the greater the voltage produced by the thermocouple. Such devices are commonly called “thermocouple gauges” or “tubes.” The manufacturing process used to make these devices generally results in variations in their performance; that is, at the same vacuum pressure and with the same filament current, the voltage produced by the thermocouple varies from device to device. To compensate for these variations, one of two methods is often used; namely, 1) test all the devices and select only those having an output that is within an acceptable range, which can be very costly, or 2) test all the devices and determine the filament current needed to achieve the same output, which means that the user of the device must be provided with this information and must make adjustments to provide the proper current. This invention provides circuitry in the Sensor, which, when used in conjunction with the Vacuum Monitor instrument in this invention (hereinafter called Monitor), provides means to compensate for the variations described above and to achieve the following unique objectives:

a) means to automatically provide the required filament current without making adjustments,

b) means to automatically enable power to be applied to the system from the battery in the Monitor without requiring manual operation of switches.

The Monitor in this invention, when connected to the Sensor, converts the voltage from the Sensor to a digital format and displays it on an LCD in the Monitor. Since the voltage vs. pressure relationship is not linear, the conversion to pressure requires a mathematical formula or a table lookup to obtain the pressure in a digital format. The methods for measuring the thermocouple voltage and converting and displaying it in a digital format are well known; however, this invention includes devices and circuitry controlled by a microprocessor and program therein that enables the Monitor to accomplish the following unique objectives:

a) provide a constant filament current that is the proper value required by the Sensor so that the Monitor can make an accurate measurement of the pressure without the need for adjustments or switching when used with any Sensor that conforms to this invention,

b) provide an LED to indicate that the filament circuit is complete,

c) provide a warning that the battery voltage is low,

d) maintain the filament current for a time necessary to reach a stable temperature; thus, ensuring that the Sensor voltage is an accurate measure of the pressure,

e) provide means to compensate for the non-linearity of the thermocouple output; thereby improving the resolution and accuracy of measurements at high pressures,

f) provide means to evaluate and analyze the Sensor voltage to indicate that the pressure is out-of-range of the device or that there is a problem with the connections,

g) enable means to turn OFF the filament current and maintain the pressure shown on the LCD for a time, after which the measurement is repeated; thus, significantly reducing the power drained from the battery, and

h) provide means to send information such as pressure and status to remote devices via a serial port in the microprocessor.

Other objectives of the present invention will be apparent from the Detailed Description.

### SUMMARY OF THE INVENTION

The invention described herein comprises a Sensor that is physically attached to a vacuum enclosure, which, when connected to the hand held Monitor in this invention, enables measuring vacuum pressure by simply connecting the electrical cable of the Monitor to the Sensor without requiring any manual action such as operating switches or making adjustments. The Monitor which includes a programmed microprocessor automatically adjusts the Sensor filament current to the value required by the Sensor, maintains the current for a set time to achieve stable conditions, reads the output voltage of the Sensor, converts the reading to a pressure in digital format and displays the pressure on its LCD. The pressure is displayed for a set time during which the filament current is OFF to conserve battery power, after which the measuring cycle is automatically repeated until the Monitor is disconnected from the Sensor. The Monitor includes an LED to indicate that the filament circuit is complete and current is flowing. The microprocessor causes the LED to flash ON/OFF to provide a warning if the battery voltage is low. The microprocessor also includes diagnostics of the Sensor voltage to indicate when the pressure is out-of-range or when abnormal conditions exist such as open leads and connections. The microprocessor in the Monitor includes a serial port that enables it to communicate and send data and status reports to external devices. The Monitor includes a Test Sensor which makes it possible to perform a full functional and calibration check of the Monitor.

### DESCRIPTION OF THE DRAWINGS

FIG. 1 is an overall system diagram of the Monitor and Sensor of this invention.

FIG. 2 is a circuit diagram of the current regulator (IR) in the Monitor of this invention.

FIG. 3 is a circuit diagram of the voltage regulator (VR) in the Monitor of this invention.

FIG. 4 is a circuit diagram of the switch device (S) in the Monitor of this invention.

FIG. 5 is a circuit diagram of amplifier (A1) in the Monitor of this invention.

FIG. 6 is a circuit diagram of amplifier (A2) in the Monitor of this invention.

FIG. 7 is a block diagram of the microprocessor (W) and associated circuits of this invention.

FIG. 8 is a diagram of the internal circuits of the Sensor of this invention.

FIG. 9 is a diagram of the internal circuits of the Test Sensor of this invention.

### DETAILED DESCRIPTION

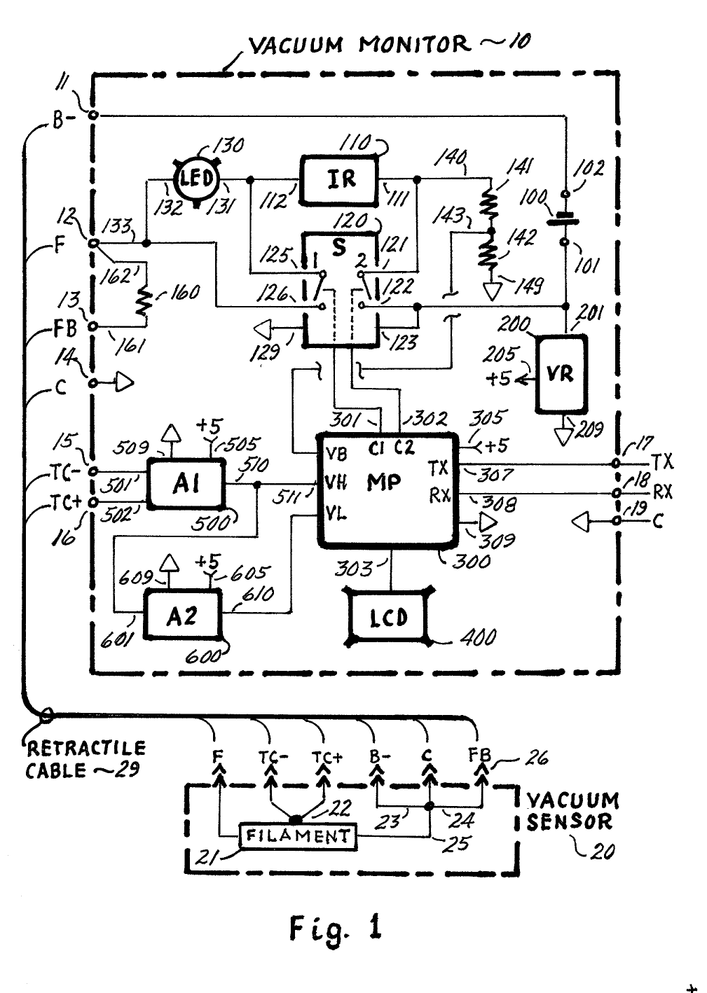

The preferred embodiment of this invention is described in this section; however, it should be understood that there may be other ways of practicing the invention and that the embodiments described herein are exemplary and not limiting. FIG. 1 is an overall system diagram showing Monitor 10 connected to Sensor 20 via a retractile cable 29. In the preferred embodiment, the devices in Monitor 10 are mounted and interconnected by printed circuits on PC cards, and the entire assembly is contained in a small, hand held, plastic case (not shown). In the preferred embodiment, Sensor 20 is typically a cylindrical, steel tube (not shown) having eight external steel pins in circular arrangement for connections, and provisions for attachment to a vacuum enclosure. The steel pins are fastened on a steel header on the tube using glass seals to prevent leakage under vacuum conditions. The internal components of Sensor 20 are attached to the pins on the inside of the header and are exposed to the vacuum of the enclosure to which Sensor 20 is attached.

Cable 29 is a retractile, multi-conductor, shielded, insulated wire cable with an overall jacket. Cable 29 is permanently connected to Monitor 10 and has an octal socket 26 to facilitate connecting it to, and disconnecting it from, the pins of Sensor 20; thus, Monitor 10 can be used to measure vacuum pressure on other Sensors. Wire “F” in cable 29 supplies the filament current from terminal 12 of Monitor 10 to filament 21 in Sensor 20 via connections 25 and 23 to the wire “B-” in cable 29 back to terminal 11 of Monitor 10. A portion of the output of current regulator (IR) 110 (described later) flowing in lead 133 to terminal 12 is bypassed to Wire “FB” via lead 162, resistor 160 and lead 161 to terminal 13. The output voltage of thermocouple 22 in Sensor 20 is connected to wires “TC−” and “TC+” in cable 29 which are connected to pins 15 and 16, respectively of Monitor 10. The small closed triangle in FIG. 1 designates a common connection of devices in Monitor 10 which is also connected to terminal 14. Wire “C” of cable 29 connected to terminal 14 of Monitor 10 connects to the junction of leads 23 and 24 in Sensor 20. Thus, attaching the octal socket 26 of cable 29 to the pins of Sensor 20 completes the circuit between wires “C” and “B−” of cable 29, which, in turn, completes the power circuits for all devices in Monitor 10.

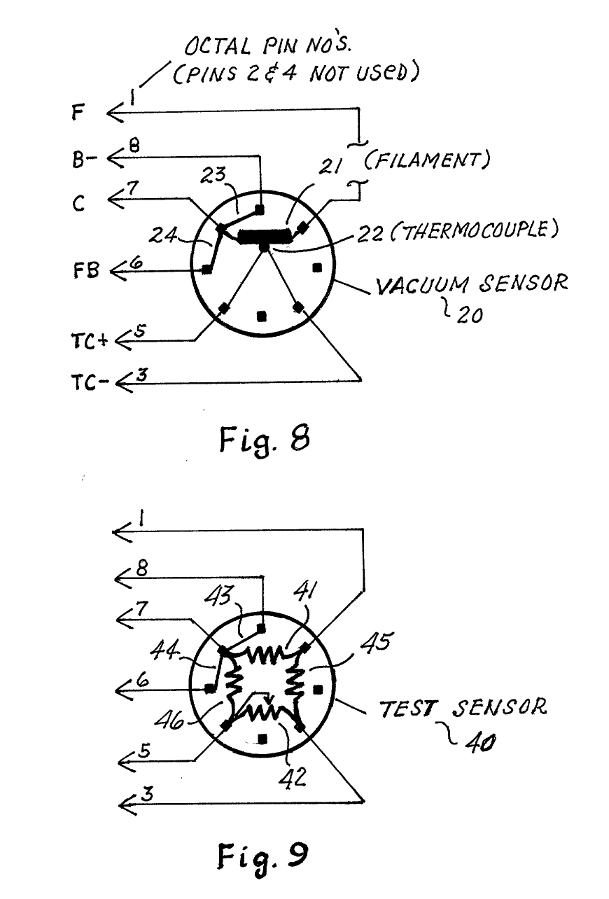

As mentioned earlier, vacuum sensors of the general type used in this invention tend to have varying characteristics; hence, to compensate for these variations in the manufacturing of the sensors, the invention includes the process whereby each sensor is provided with an internal jumper (lead 24 between pins 6 and 7 of Sensor 20 shown in FIG. 8) during assembly. After assembly, each sensor is tested at a specified vacuum pressure and the current thru filament 21 shown in FIG. 8 is adjusted to obtain a specified voltage output of thermocouple 22 on pins 3 and 5. Using this process, the sensors can be divided into two groups; namely, those having a filament current in an upper range and those in a lower range. Referring again to FIG. 1, at terminal 12 of Monitor 10, most of the current flows in wire “T” of cable 29 to filament 21 in Sensor 20, and a small current is by-passed thru lead 162, resistor 160 and lead 161 to terminal 13, which in turn, flows in wire “TB” of cable 29 to internal jumper 24 of Sensor 20. Both the filament current and the by-pass current return to Monitor 10 via jumper 23 in Sensor 20 and wire “B−” of cable 29. The constant current obtained from the current regulator(IR) 110 would typically be 17.3 mA, and resistor 160 would be selected to bypass a portion of current so that the current in wire “F” to the filament falls in the lower range of currents obtained from the tests described above. For example, assuming that the lower range of test currents is from 16.5 to 16.9 mA, the resulting filament current provided by the Monitor would be 16.7 mA. and would be supplied to all sensors in that group. For sensors requiring a higher range of filament currents such as 17.0 to 17.5 mA, jumper 24 from pins 6 to 7 of Sensor 20 shown in FIG. 8 would be burned open by passing a high current through it at the final stage of the process; thus, opening the by-pass circuit resulting in a filament current from the Monitor of 17.3 mA. for all sensors in the upper range of currents. By the above means, the Monitor can be used with sensors produced by the process described in this invention having two ranges of filament currents without the need for making adjustments or switching.

FIG. 1 shows how power is supplied to devices in Monitor 10. The power source is a 9 Volt battery 100 with negative terminal 102 connected to terminal 11. The positive terminal 101 of battery 100 supplies power directly to switch device (S) 120 and voltage regulator (VR) 200. Voltage regulator (VR) 200 (described in detail later) provides a regulated 5 volt supply (shown as +5) to amplifier (A1) 500, amplifier (A2) 600 and microprocessor (MP) 300. The small closed triangles in FIG. 1 designate that all devices with this symbol are electrically connected to a common point within Monitor 10. Wires “B−” and “C” of cable 29 connected to terminal 11 and 14, respectively, of Monitor 10 are connected together by jumper 23 in Sensor 20 when the octal socket 26 of cable 29 in attached to the pins of Sensor 20; thus, completing the power circuits when Monitor 10 is connected to Sensor 20. This means of completing the power circuits eliminates the need for an ON/OFF power switch, which in turn, eliminates the risk of draining power from the battery in the event that the switch is accidently left ON.

FIG. 8 shows the details of jumpers 23 and 24 in Sensor 20 which provide the important bypass and power connections described in the above paragraphs. The internal connection of these jumpers to adjacent pins 6, 7 and 8 makes it possible to minimize the number of wires in cable 29. Also, wire “B−” in cable 29 is the drain wire of the shield in the cable, and hence, performs a dual function of providing the return wire to the battery negative terminal (102 of Monitor 10 in FIG. 1) while providing an effective shield for the other wires.

FIG. 9 shows the details of Test Sensor 40. It uses the same basic shell of Sensor 20 but without provisions for attachment to a vacuum enclosure. Test Sensor 40 is mounted in the same case (not shown) with Monitor 10 so that it is readily available to perform a full functional and calibration check by simply connecting cable 29 of Monitor 10 to Test Sensor 40. Internal jumpers 43 and 44 duplicate the function of jumpers 23 and 24 in Sensor 20. Internal resistors 45 and 46 and potentiometer 42 provide a voltage on pins 3 and 5 to simulate the output voltage of thermocouple 22 in Sensor 20 without requiring a vacuum.

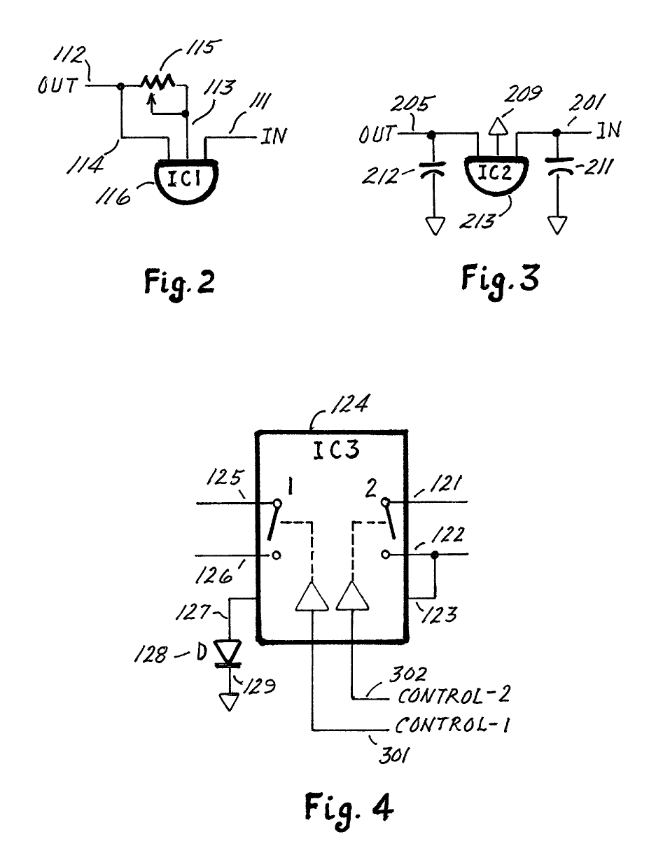

Current regulator (IR) 110 in FIG. 1 is shown in detail in FIG. 2. It comprises IC1 (116) which is an integrated circuit voltage regulator operating in a current mode to regulate the output current on lead 112. The constant current output is adjusted by potentiometer 115. Output (112) is connected to input 131 of LED 130, and output 132 is connected to lead 133 which is the supply of filament current to terminal 12 of Monitor 10 in FIG. 1. Referring to FIG. 1, input 111 of current regulator (IR) 110 is obtained from battery 100 via leads 101, 122, switch-2 in Switch device (S) 120 and lead 121. Current regulator (IR) 110 has the ability to maintain the output current relatively independent of changes in the total resistance of the output circuit.

Voltage regulator (VR) 200 in FIG. 1 is shown in detail in FIG. 3. It comprises IC2 (213) which is a low dropout, 5 volt integrated voltage regulator with capacitor 211 on input 201 from battery 100 and capacitor 212 on the 5 volt output 205.

Switch device (S) 120 in FIG. 1 is shown in detail in FIG. 4. It comprises IC3 (124) which is an integrated circuit with two, single pole, normally open analog switches controlled by inputs 301 and 302 which, in turn, are controlled by microprocessor (MP) 300 in FIG. 1. Power for IC3 (124) is obtained from battery 100 via leads 123 and 101, and the power return circuit is lead 127 connected to diode (D) 128 to common 129. When control voltage is applied to input 301, switch-1 in 124 closes, and when control voltage is removed the switch opens. Switch-2 in 124 operates in a similar fashion. Referring to FIG. 1, the application of control voltage from microprocessor (MP) 300 to input 302 causes switch-2 in Switch device (S) 120 to close and complete the circuit from 122 to 121; thus connecting battery voltage to input 111 of current regulator (IR) 110 and to a resistor voltage divider circuit (described later). The presence of voltage at input 111 of current regulator (IR) 110 causes it to produce a constant current at its output 112 which flows thru LED 130 and to terminal 12 of Monitor 10 as described earlier, assuming that switch-1 in Switch device (S) is open.

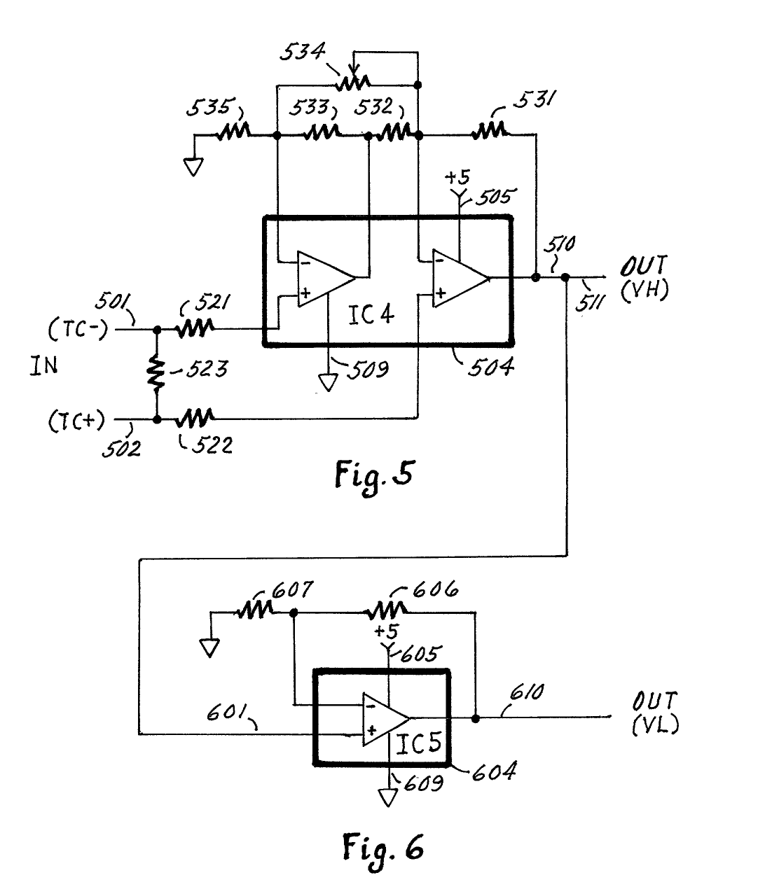

Referring to FIG. 1, the voltage output of thermocouple 22 in Sensor 20 is connected to terminals 15 and 16 of Monitor 10 via wires “TC−” and “TC+” in cable 29 which is input on leads 501 and 502 to amplifier (A1), the details of which are shown in FIG. 5. It comprises a dual operational amplifier integrated circuit (IC4) 504 with feedback circuits consisting of resistors 531, 532, 533, 534, and 535 and input resistors 521, 522 and 523, all of which in combination function as a high impedance, differential amplifier. The gain of amplifier (A1) is adjusted by potentiometer 534. Power is supplied by lead 505 connected to the +5 Voltage of voltage regulator (VR) with common return at 509. The output 510 of amplifier (A1) is connected to input (VH) 511 of microprocessor (MP) 300, and is also connected to input 601 of amplifier (A2).

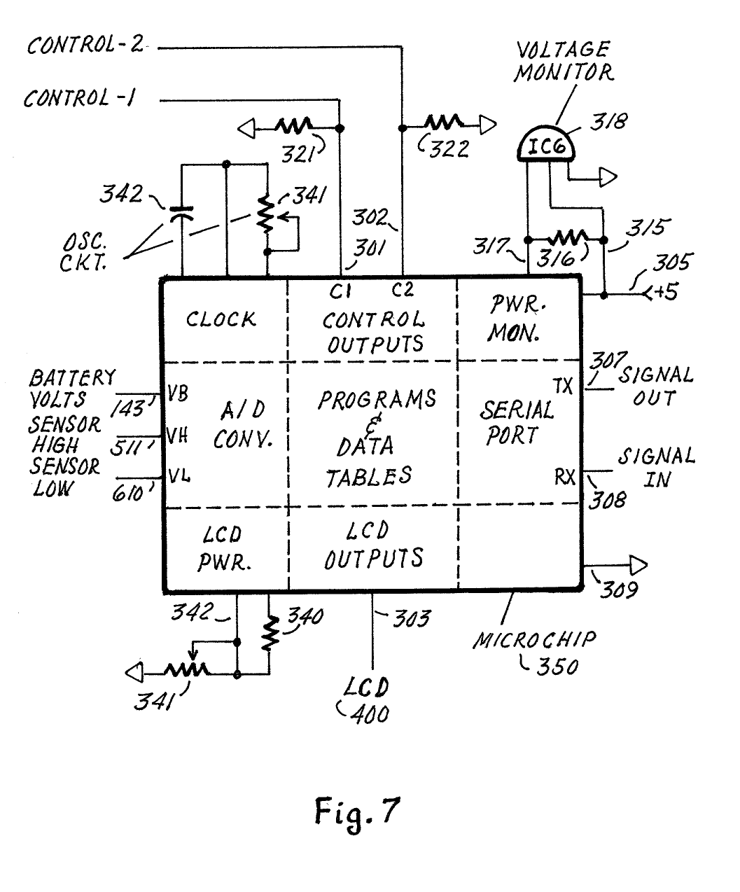

The details of anplifier (A2) are shown in FIG. 6. It comprises a single operational amplifier integrated circuit (IC5) 604 with a fixed gain feedback circuit consisting of resistors 606 and 607. Power is supplied by lead 605 connected to the +5 Voltage of voltage regulator (VR) with common return 609. The output 610 is connected to input (VL) of microprocessor (MP) 300. The use of amplifier (A2) in conjunction with microprocessor (MP) provides a unique means of improving the resolution and accuracy of the measurements at high pressures, which is explained as follows. Microprocessor (MP) contains an analog to digital (AID) converter (see FIG. 7) which typically has a fixed resolution expressed in millivolts per bit, and each bit represents the smallest change in pressure that can be recognized by the program. The voltage output from the thermocouple in the sensor is low at high vacuum pressures, but more important, the non-linearity of the output at high pressures produces small changes in voltage for relatively large changes in pressure which, in effect, means that each bit of data corresponds to a large change in pressure. As shown in FIG. 1, the voltage output from the thermocouple is initially amplified by amplifier (A1) and further amplified by (A2) which produces larger changes in its voltage output for the same pressure changes resulting in greater resolution. Both amplifier outputs are connected to the A/D converter of Microprocessor (MP) and the program therein first evaluates the output of (A1) on VH, and if the voltage is above a predetermined value, that input is converted to a pressure and displayed on the LCD. If the voltage on VH is below the predetermined value, the program uses the voltage on VL to convert to pressure, thus, providing a higher resolution when the vacuum pressures are high.

The microprocessor (MP) with its associated circuits is shown in FIG. 7. Microchip 350 is a CMOS, high performance, RISC programmable processor with on-chip EPROM program memory. The functions of each block are described below:

CLOCK: establishes the operating frequency of the processor using an RC oscillator circuit consisting of capacitor 342 and potentiometer 341 to adjust the frequency.

CONTROL OUTPUTS: provides output voltages for control functions; specifically, outputs (C1 and C2) to control switches 1 and 2 in Switch device (S) 120 (shown in FIG. 1). Resistors 321 and 322 are connected to output leads 301 and 302, respectively, to prevent spurious voltages from causing uncontrolled operation of the switches.

PWR. MON.: provides monitoring of the power supply voltage to reset the processor when normal voltage is restored following a low voltage condition. The circuit consists of a precision voltage monitor integrated circuit (IC6) 318 and resistor 316 which continuously monitors the 5 Volt power supply 305.

A/D CONV.: analog to digital converter which converts the following analog voltages to digital values

input (VB) 143 used to measure battery voltage which is derived from lead 140, voltage divider resistors 141 and 142 to common 149 (see FIG. 1).

input (VH) 511 from amplifier (A1) used to measure the high range of voltages from thermocouple 22 in Sensor 20.

input (VL) 610 from amplifier (A2) used to measure the low range of voltages from thermocouple 22 in Sensor 20.

SERIAL PORT: transmits output signals on 307 and receives input signals on 308 to communicate and send serial data and status to external devices.

LCD PWR.: provides means for adjusting the power and intensity of LCD display 400 using resistor 340 and potentiometer 341 connected to common 341.

LCD OUTPUTS: represents the LCD drivers which provide the necessary voltages to activate the 3 digit LCD display 400.

PROGRAMS & DATA TABLES: the programs which control the operation of the system and the data tables used to convert the input voltages to pressure are stored in the EPROM of microchip 350.

The basic sequence of operations will now be described using FIG. 1. The details of the operation of circuits and devices were described in the preceding paragraphs. When the retractile cable is connected to the Sensor, power is applied to devices in the Monitor. The microprocessor (MP) initializes parameters and momentarily displays 888 on the LCD to indicate that all segments of the display are operating properly. It then produces an output (C2) to cause switch-2 of Switch device (S) to close which applies battery voltage to current regulator (IR), which, in turn produces a preset current to LED and to the filament in the Sensor via wire “F” in the cable. The filament current flows for a preset time (approximately 10-seconds) allowing it to reach a stable temperature and during this time, the battery voltage is sensed at input (VB) of microprocessor (MP), and if the battery voltage is low, it produces a momentary output (C1) to cause switch-1 of Switch device (S) to close, bypassing the LED which causes it to flash to give a visual indication of the low battery condition. (Note: the current regulator (IR) maintains a constant current even during the flashing of the LED.) At the end of the filament heating time, the output voltage of the thermocouple in the Sensor is measured across wires “TC−” and “TC+” of the cable using amplifier (A1) providing input (VH) to the microprocessor (MP). The output of amplifier (A1) is also connected to the input of amplifier (A2) providing input (VL) to microprocessor (MP). The program evaluates the inputs and performs the following functions:

selects which input (VH or VL) to use to convert to pressure and displays the pressure on the LCD

if the input is out-of-range and it causes the LCD to display a flashing 999.

if the input indicates an abnormal condition such as open thermocouple leads or open wires in the cable it causes the LCD to display a flashing 000.

After the display is generated, the program turns off the control outputs (C1 and C2) which causes switches (1 and 2) in Switch device (S) to open; thus, removing power from the current regulator (IR) and turning off the filament current and the LED to conserve battery power. During this period (approximately 10-seconds), the pressure value is maintained on the display and communications is established with a remote device (if connected) and data and status sent via the serial port (TX and RX). After the display time, the program re-starts the filament current process so that new pressure readings are displayed every 20-seconds. As an option, the program can be set to provide a continuous filament current and shorter times (such as 1-second) for display periods.

While the foregoing is a detailed description of the preferred embodiment of the invention, the claims which follow define the general scope of invention. Modifications or improvements in the preferred embodiments should be treated as within the scope of invention insofar as they are equivalent or otherwise consistent with the contribution over prior art.

I claim:

1. Apparatus and process consisting of a Sensor to measure vacuum pressure comprising: circuitry in the Sensor and process which enables means to provide the filament current
required by the thermocouple in the Sensor without making adjustments; circuitry in the Sensor which enables the application of power to the Monitor of claim 2
when connected together by a cable with a minimum number of wires;

2. A Monitor apparatus used in conjunction with the Sensor of claim 1 measures and displays vacuum pressure comprising:
circuitry and devices giving means to provide a constant and proper filament current to the Sensor of claim 1 without the need for manual switching or adjustments;
a microprocessor and programs to control a switching device in the Monitor that provides means for cycling the filament current on/off to conserve battery power;
amplifier circuits used with an A/D converter in the microprocessor with programs therein providing means to improve the resolution and accuracy of measurements at high vacuum pressures;

3. A microprocessor in the Monitor of claim 2 with programs that control the operation of:
an output which controls switching of filament current to the Sensor of claim 1;
an output which bypasses the LED in the Monitor to provide means for visual indication of a low battery condition;
conversion of an A/D input used to monitor battery voltage;
conversion of an A/D input representing a high range of voltages from the Sensor of claim 1 which is converted to pressure using a lookup table;
conversion of an A/D input representing a low range of voltages from the Sensor of claim 1 which is converted to pressure using another lookup table;
provides appropriate signals to the LCD to display pressure measurements;
provides evaluation of A/D input voltages from the Sensor of claim 1 to detect abnormal conditions and display unique values on the LCD to indicate such conditions;
transmit and receive signals on the serial port to communicate and send data and status to remote devices.

4. Apparatus consisting of a Test Sensor providing means to simulate the operation of the Sensor of claim 1 at a predetermine pressure without the need for a vacuum.
